(19) United States
(12) Patent Application Publication
(10) Pub. No.: US 2025/0188780 A1
(43) Pub. Date: Jun. 12, 2025

(54) Panel door with radial track detachable hinge system and method

(71) Applicant: Reggie L. Bolden, Las Vegas, NV (US)

(72) Inventor: Reggie L. Bolden, Las Vegas, NV (US)

(21) Appl. No.: 18/972,795

(22) Filed: Dec. 6, 2024

Related U.S. Application Data
(60) Provisional application No. 63/629,844, filed on Dec. 6, 2023.

(51) Int. Cl. E05D 15/24; E05D 15/22; E06B 3/48

(52) U.S. Cl. CPC E05D 15/242; E05D 15/22; E06B 3/485; E05D 2015/225; E05Y 2201/484; E05Y 2201/686; E05Y 2201/688; E05Y 2800/236; E05Y 2900/106

(57) ABSTRACT

The invention comprises a double roller garage door panel hinge and method for same. The hinge comprises a first hinge half and a second hinge half that are removably and pivotally connected to each other by a clasp formed by the second hinge half; the first hinge half further comprises a first half hinge base that supports a first roller support tube up and away from a first half hinge base, the first roller support tube rotatably supports a first garage door roller; the second hinge half further comprises a second half hinge base that supports a second roller support tube up and over the second half hinge base, the second roller support tube rotatably supports a second garage door roller; wherein the first hinge half is attached to first garage door panel and the second half hinge is attached to an adjacent garage door panel.

### CROSS-REFERENCE TO OTHER APPLICATIONS

This present application claims the benefit of U.S. Provisional Patent Application No. 63/629,884 filed on Dec. 6, 2023, and entitled “Panel Door with Radial Track Detachable Hinge System and Method”, the entire contents of which are incorporated by reference.

### STATEMENT REGARDING FEDERALLY SPONSORED RESEARCH OR DEVELOPMENT

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### STATEMENT REGARDING PRIOR DISCLOSURES BY THE INVENTOR OR A JOINT INVENTOR

Not Applicable.

### FIELD OF THE INVENTION

The present invention may relate to garage doors that may be in the form of hingedly connected stacked panels that may be movably connected to a rail set. More specifically, the present invention may further relate to said stacked panels connected by hinges, the hinges may comprise of two removably attached hinge halves with each hinge half substantially supporting a respective rail engaging roller.

### BACKGROUND

Garage doors may be in a form of linked, multiple stacked panels, movably connected to a set of spaced-apart rails that may be connected to a garage structure to reversibly secure a garage (e.g., vehicle) entrance or opening The panels may be pivotally connected to one another by a set of panel hinges that pivot as the panels move through a radius of the rail/track set between a vertical secure portion of the rail/track set to a horizontal or slightly angled storage portion of the rail/track set. Some panel hinges (e.g., roller panel hinges) may be located substantially adjacent to the sides of the garage panel door that may further movably support rollers (e.g., wheels with axles, wherein the wheel may movably engage the rail/track set.) The roller panel hinge may lift the respective roller up and apart from the reminder of the roller panel hinge. Generally, the roller panel hinge may locate the roller (wheel/axle) to lie over the central pivot point of the adjacent respective top and bottom edges of the two panels connected by the roller panel hinge. Other panel hinges (e.g., non-roller panel hinges) that generally lack this roller feature may be located away from the panel door edges proximate to rail/track set.

The panel garage door may further comprise a set of non-hinge mounted rollers (e.g., a plate movably supporting a roller apart from and above the said plate.) These non-hinge mounted rollers may be located at the corners of the garage panel door (e.g., top corners of the top panel and bottom corners of the bottom panel.) These non-hinge mounted rollers may also movably engage the rail set to substantially direct the top and bottom edges of the garage panel door through the rail set.

The roller panel hinges may be numbered (e.g., 1-5) according to the roller depth (e.g., spacing between the roller and base of the roller panel hinge.) This selected roller depth may be significant in relation to “flush fitting” garage panel door applications wherein the garage panel door removable seals to the garage door framework opening. In such cases, the vertical closed portions of the rail/track set, generally being located proximate to the garage door opening framework, may actually be slighted angled off (e.g., 5-10 degrees) from vertical with the bottom portion of the vertical portions track/rail set being closest to the garage door opening framework while the top portion of the vertical portions of track/rail set generally being the farthest away from garage door opening framework. Roller panel hinges may then be selected (e.g., by roller depth) to adjust the distance of a panel from the track/rail set's vertical portions to substantially ensure the panel in the closed position meets up with the garage door framework. Roller panel hinges with lower roller values (i.e., numbering) are generally placed on the bottom & lower panels that are located closer to the rail/track set than the top and upper panels. Roller panel hinges with higher roller depth values (i.e., numbering) are generally used on upper and top panels. The rollers of the selected roller panel hinges may then push the roller panel hinges and their respective attached panels away from the respective vertical rail/track portions to “wedge” the garage panel door into removable flush-fit seal against the garage door opening framework. In this manner, as the garage panel door generally moves from a horizontal storage position down to a vertical securing position, the garage panel door may be “wedged” against the garage door opening framework to substantially form a reversibly sealed garage door closure.

Additionally, to assist the closing and opening of the paneled garage doors, the said garage panel doors may be operated in conjunction with spring-based counter balancing system. This system may be based on either extension or torsion springs, although torsion spring-based counter balancing system is the industry standard. The system may be connected to the garage panel door to substantially counter balance the weight of the garage panel door and provide the vast majority of the lift force utilized when raising the garage door from the vertical position to the horizontal position (and for generally controlling the descent of the garage panel door from horizontal/angled position to vertical position as well.) The torsion spring-based counter balance system may comprise a torsion spring shaft (e.g., usually rotatably connected to the garage structure) having associated specific torsion spring(s) to substantially assist in controlling the movement lifting the garage door. The torsion spring strength is generally relative to the garage panel door's weight.

Further, at each end of the torsion spring shaft could be attached a respective cable drum. A cable could be attached by one cable end to the cable drum allowing the said cable to be wrapped about and unwrapped from the respective cable drum during garage panel door operations. The other cable end could be attached to the base plate of a respective non-hinge mounted roller (e.g., located at a respective bottom corner of the bottom panel). In this manner, the torsion spring counter balancing system is substantially connected to the both bottom corners of the garage panel door.

One possible version of a garage panel door could use sets of bifurcated panel hinges (e.g., roller and non-roller types.) Both bifurcated panel hinge types could comprise two hinge halves that are pivotally and removable attached to one another by a hinge half locking mechanism. Generally speaking, the hingedly bifurcated panel hinge would have one hinge half substantially attached to a first garage door panel (e.g., upper panel) proximate to a bottom edge of the first garage door panel. The second hinge half could be attached proximate to atop edge of a second garage door panel (e.g., lower panel), the said top edge being further adjacent to the bottom edge of the first garage door panel. By deactivating the locking mechanism removably connecting the two hinge halves together, the respective half hinges of the bifurcated panel hinge could be released from one another to generally allow separation of the adjacent garage door panels from one another as well as allowing the two panels be quickly and easily be hingedly and removably reattached to one and another. The garage door pane's hinge attachment/release capability could allow for greater ease of garage door installation, removal, repair and other effects.

The roller type bifurcated panel hinge could employ multiple rollers (e.g., two rollers) to engage the rail/track set. Each hinge half could further comprise a roller support that movable holds a respective roller. Many such bifurcated panel hinges could have a roller substantially located directly above and apart from the remainder of the said hinge half.

Further, such double roller garage door panel hinge system could possibly allow the one or more panel(s) (e.g., top/upper panels to be separated from remainder portion of the garage panel door. The released panels could be moved to another portion of the rails/track set (e . . . , moving from vertical closed position-rail/track set portion, through the curved rail/track set portion to the horizontal or angled (e.g., storage) position-rail/track set portion. This released panel action could allow the lower garage door portion of panel(s) (generally still in the vertical closed position-rail/track set portion) to act as a fence to the garage opening while allowing the open space created by moving the upper garage door panel(s) to substantially provide free air flow between the garage interior and outside environment to substantially provide garage ventilation. Generally, just partially raising the entire the garage door to substantially open up the bottom portion of the garage opening will not be sufficient to allow an outside environment to cool off a hot garage interior. Further, such a garage opening fence may limit the view of others outside the garage being to see the entire garage interior directly. Bottom panel fence in the vertical closed portion may protect children, small animals or others from otherwise crawling under the partially open garage to pass freely through the entire garage.

In one version, during panel separation and subsequent movement, the torsion or extension spring-based garage door weight compensation system may need to be locked down or otherwise secured. Otherwise, the weight compensation system, still loaded for the total garage door weight, could dangerously cause the bottom panel to rise on the rail/track set when the upper panel(s) are attempted to be separated and moved on the rail/track set. One such securing system could have the bottom panel may further comprise door lock(s) that may removably engage the rail/track set to hold the bottom panel in place (in the vertical closed position) when the weight of the upper panel(s) is removed from the remainder of the garage doors and are moved to track/rail set's horizontal portion.

One possible issue with such double roller removably bifurcated garage door panel hinges may be that the top half hinge's roller location could interfere with the panel garage door moving through the rail/track set's radius (e.g., curved track/rails) as generally set between the vertical securing position-rails/track set vertical portion and the horizontal or angled storing position-rail/track set horizontal or angled portion. This issue may be further illuminated when a garage panel door, in the closed position utilizing the “wedge” securing technique, is “flush mounted” against the garage door opening framework is moving towards the open or storage door position.

In such panel movement, the top panel may have a non-hinge supported roller proximate to the top panel's top edge while another roller may be supported by bifurcated detachable half hinge located proximate to the top panel's bottom edge. The top panel's two rollers, as the top panel enters the curved portion of the rail/track set from the vertical portion, may lift or otherwise angle upward the top panel's lower edge from the rail/track set enough to substantially jam or lockup top panel's lower edge into the garage door opening framework. This lockup or jamming of the top panel may be due to the placement of the lower roller of the top panel (the top panel's double roller hinge's top roller (e.g., up from and over the top panel's lower portion and proximate to the top panel's lower edge.)

Another possible issue with double roller removably bifurcated garage door panel hinges could be that such hinge sandwiches the adjacent panels' pivot point between the hinge's pair of rollers (e.g., hinge places one roller above and other roller below the central hinge pivot point of adjacent connected removably connected by said hinge). Such roller may not allow the fully connected garage panel door to move through the radius of the rails/tracks set. The curvature constraint imposed by the track/rail set may tend to break such hinges trying to pass through the rail/track set curvature does not allow such double roller locations to move through the track/rail set radius when affixed to the panels. What could be needed is a double roller, detachable, bifurcated garage door panel hinge whose placement of associated roller(s) could ameliorate the stated issues and allow the panel passage through the rail/track set curves.

### SUMMARY OF ONE EMBODIMENT OF THE INVENTION

### Advantages of One or More Embodiments of the Present Invention

The various embodiments of the present invention may, but do not necessarily, achieve one or more of the following advantages:
the ability to move double roller garage door panel detachable hinge through the curves of garage door rail/track set;
provide a double roller garage door panel detachable hinge that comprises removable attached hinge halves, each hinge half supporting a roller, when in at least one roller is offset from respective hinge half's base;
the ability to removably bifurcate a double roller garage door panel hinge into separate hinge halves, each hinge half supporting a respective roller;
provide a double roller garage door panel hinge that comprises removable attached hinge halves, each hinge half supporting a roller, wherein the two rollers are substantially tandemly adjacent to one another when the connected hinge halves are in the same plane;
the ability of a set of double roller garage panel door detachable hinges and non-roller garage door panel detachable hinges to allow a set of garage door panels to be easily attached and detached from one another as well as allow said panels, when removably attached to one another, to move the through the curves of garage door rail/track set; provide a double roller garage door panel detachable hinge that comprises removably
attached hinge halves, each hinge half supporting a roller, wherein the two hinge rollers are substantially tandemly adjacent to one another and may be located over the same hinge half when the hinge halves are connected together and lying in the same plane;
the ability of panels of a garage panel door to be separated from one another to allow a allow one or more panel(s) to be removed from the remaining panels (located in a vertical closed position) and moving the released panel(s) into a horizontal/angled section of the garage rail/track set;
provide a garage panel door wherein the panels could be separated from one another while movably located on a garage rail/track set to form a garage opening fence that also provides outside ventilation to the garage interior; and
provide a set of double roller garage panel door detachable hinges and non-roller garage door panel detachable hinges to allow a set of garage door panels removably connected by such hinges to form gap to open up between the otherwise adjacent panels top and bottom edges as the said panels move through the curves of the associated rail/track set and to further facilitate respective panel's movement through the said curves.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a double roller, bifurcated, detachable garage door panel hinge and method for same. The hinge could comprise a first hinge half and a second hinge half that are substantially removably and pivotally connected to each other by a clasp generally formed by the second hinge half; the first hinge half further may comprise a first half hinge base that substantially supports a first roller support tube up and away from a first half hinge base, the first roller support tube may rotatably support a first garage door roller; the second hinge half further may comprise a second half hinge base that substantially supports a second roller support tube up and over the second half hinge base, the second roller support tube rotatably supports a second garage door roller; wherein the first hinge half may be attached to first garage door panel and the second half hinge may be attached to an adjacent garage door panel.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of one embodiment of the double roller garage door panel hinge with the clasp in the downward position of the present invention.

FIG. 2 is substantially a close-up perspective view of the section marked A in FIG. 1.

FIG. 3 is substantially a top view of one embodiment of the double roller garage door panel hinge with the clasp in the downward position of the present invention.

FIG. 4 is substantially a side elevation view of one embodiment of the double roller garage door panel hinge with the clasp in the downward position of the present invention.

FIG. 5 is substantially an end elevation view of one embodiment of the double roller garage door panel hinge with the clasp in the downward position of the present invention.

FIG. 6 is substantially a side elevation view of one embodiment of the double roller garage door panel hinge with the clasp in the downward position, the hinge being attached to two adjacent garage door panels of the present invention.

FIG. 7 is substantially a top view of one embodiment of the double roller garage door panel hinge's first hinge half of the present invention.

FIG. 8 is substantially a side elevation view of one embodiment of the double roller garage door panel hinge's first hinge half of the present invention.

FIG. 9 is substantially a perspective view of one embodiment of the double roller garage door panel hinge's first hinge half of the present invention.

FIG. 10 is substantially a top view of one embodiment of the double roller garage door panel hinge's second hinge half with clasp in the downward position of the present invention.

FIG. 11 is substantially a side elevation view of one embodiment of the double roller garage door panel hinge's second hinge half with clasp in the downward position of the present invention.

FIG. 12 is substantially a perspective view of one embodiment of the double roller garage door panel hinge's second hinge half with clasp in the downward position of the present invention.

FIG. 13 is substantially a top view of one embodiment of the double roller garage door panel hinge's second hinge half with clasp in the upward position of the present invention.

FIG. 14 is substantially a side elevation view of one embodiment of the double roller garage door panel hinge's second hinge half with clasp in the upward position of the present invention.

FIG. 15 is substantially a perspective view of one embodiment of the double roller garage door panel hinge's second hinge half with clasp in the upward position of the present invention.

FIG. 16 is substantially a perspective view of one embodiment of the double roller garage door panel hinge with the clasp in the upward position of the present invention.

FIG. 17 is substantially a top view of one embodiment of the double roller garage door panel hinge with the clasp in the upward position of the present invention.

FIG. 18 is substantially a side elevation view of one embodiment of the double roller garage door panel hinge with the clasp in the upward position of the present invention.

FIG. 19 is substantially a rear elevation view of one embodiment of the double roller garage door panel hinge with the clasp in the upward position of the present invention.

FIG. 20 is substantially a side elevation view of one embodiment of the double roller garage door panel hinge with the clasp in the upward position with the hinge attached to two adjacent panels of the present invention.

FIG. 21 is substantially a side elevation view of one embodiment of the double roller garage door panel hinge with the clasp in the upward position, the hinge display the clasp release of the present invention.

FIG. 22 is substantially a top elevation view of one embodiment of the double roller garage door panel hinge and non-roller garage door panel hinge as attached to two formerly adjacent panels, now separated, of present invention.

FIG. 23 is substantially a top elevation view of one embodiment of the double roller garage door panel hinge with roller pair of present invention.

FIG. 24 is substantially a flowchart schematic showing one possible embodiment of a process/method for operating the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

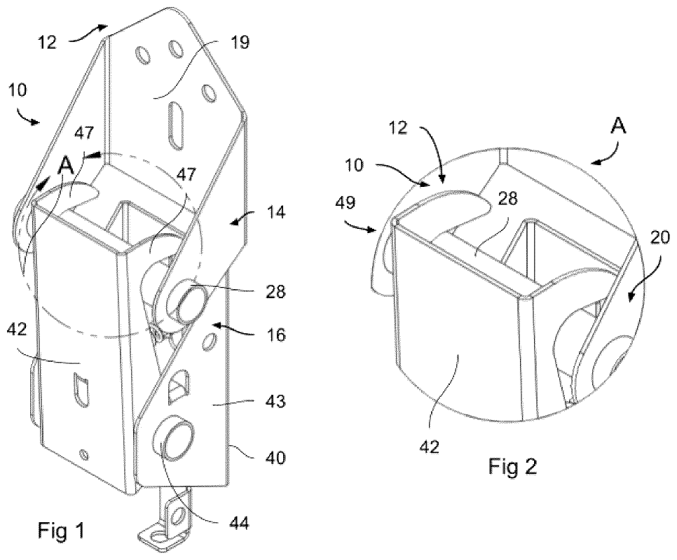

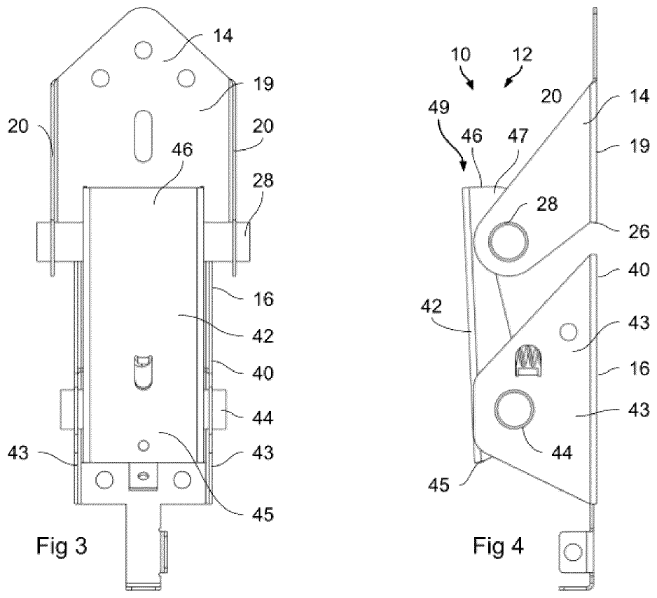

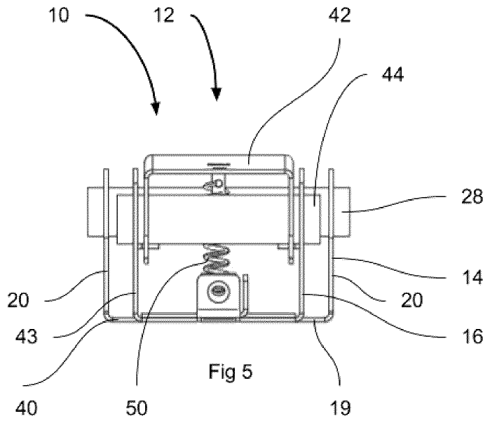

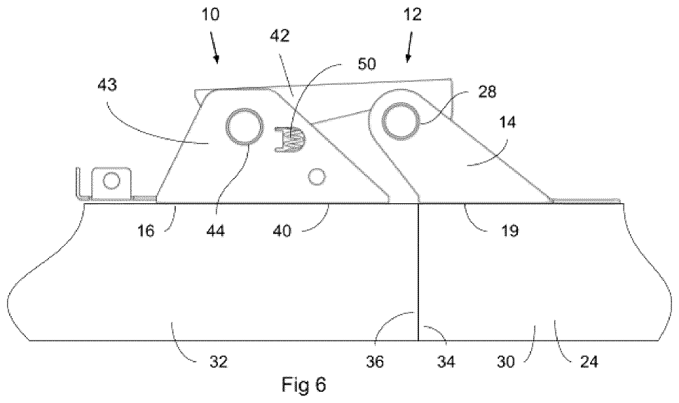

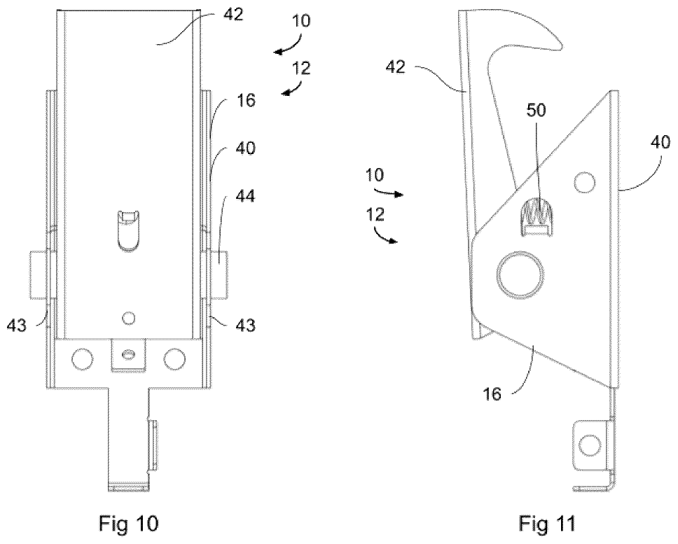

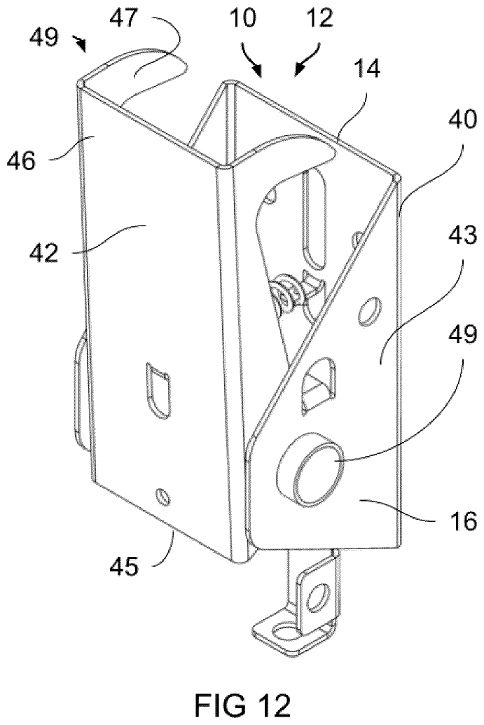

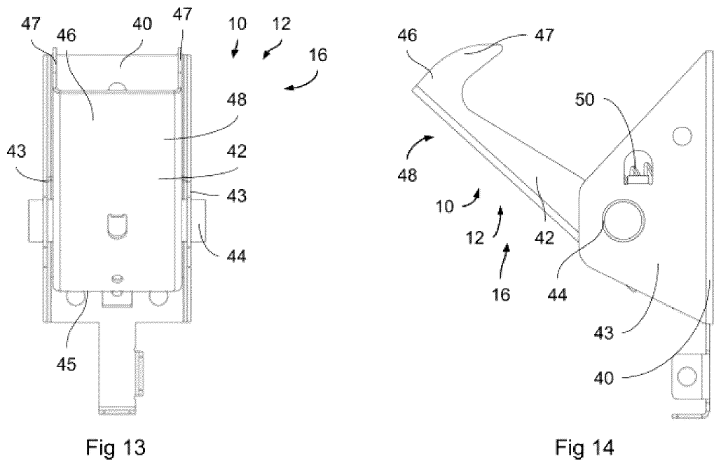

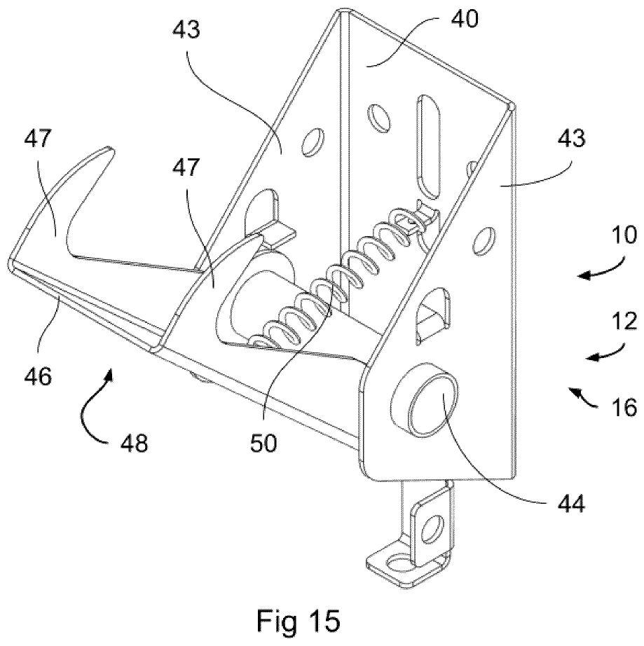

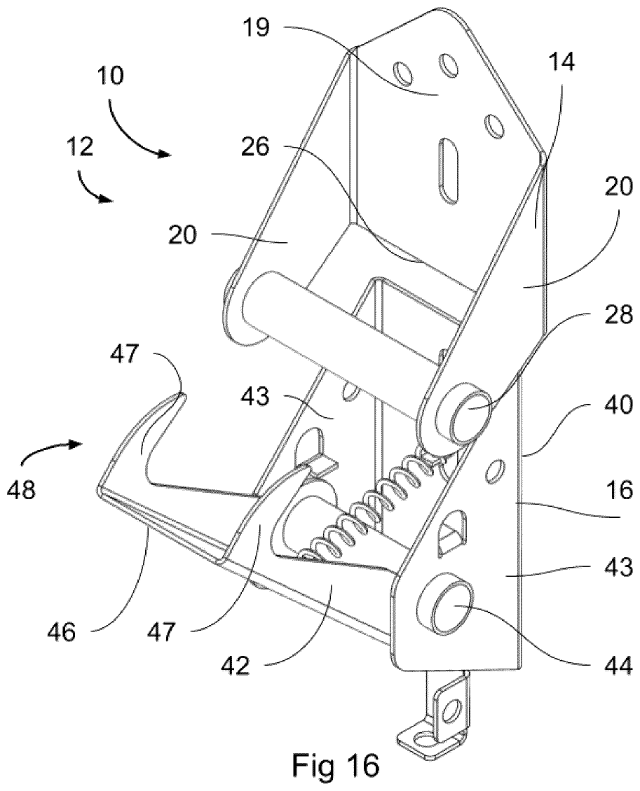

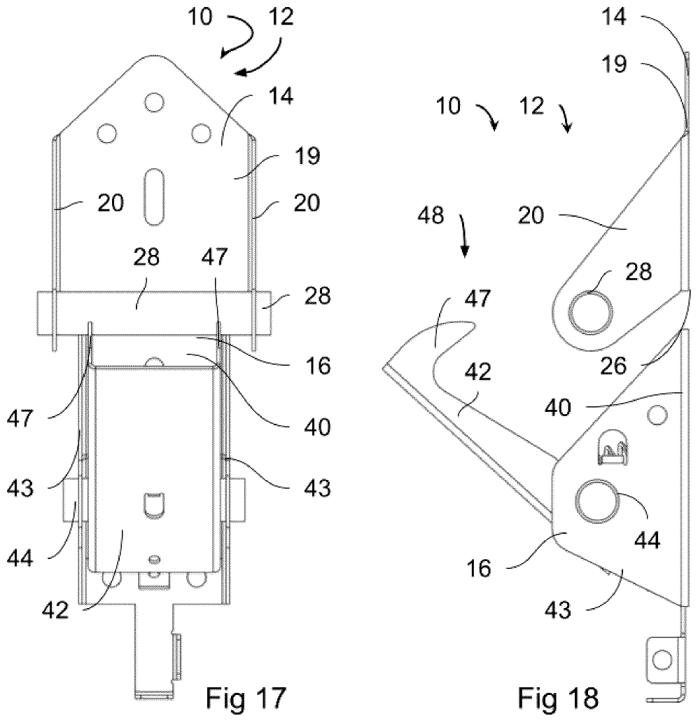

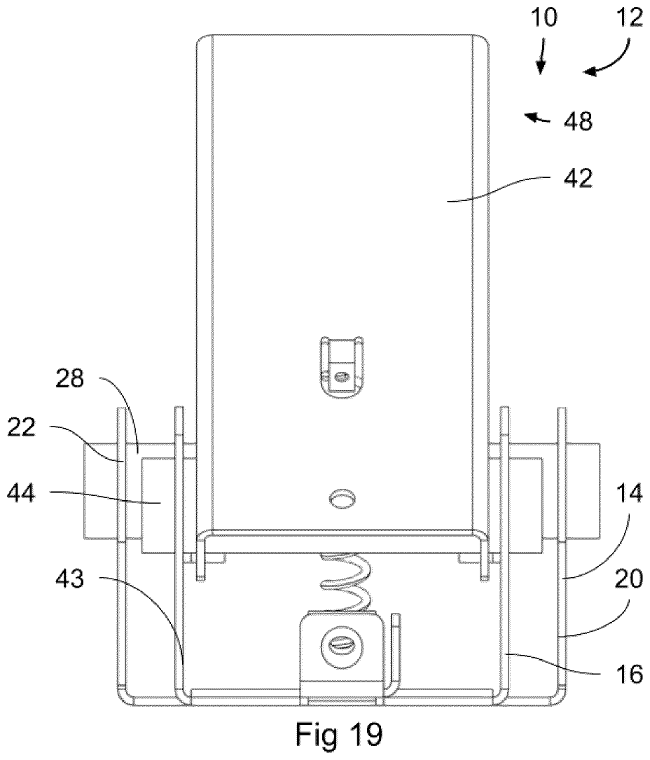

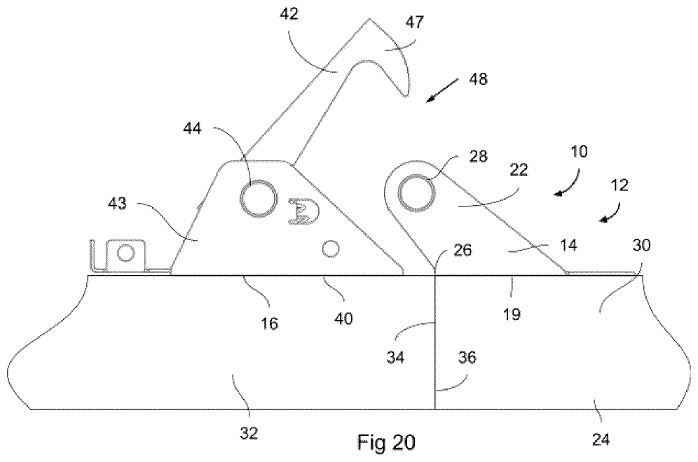

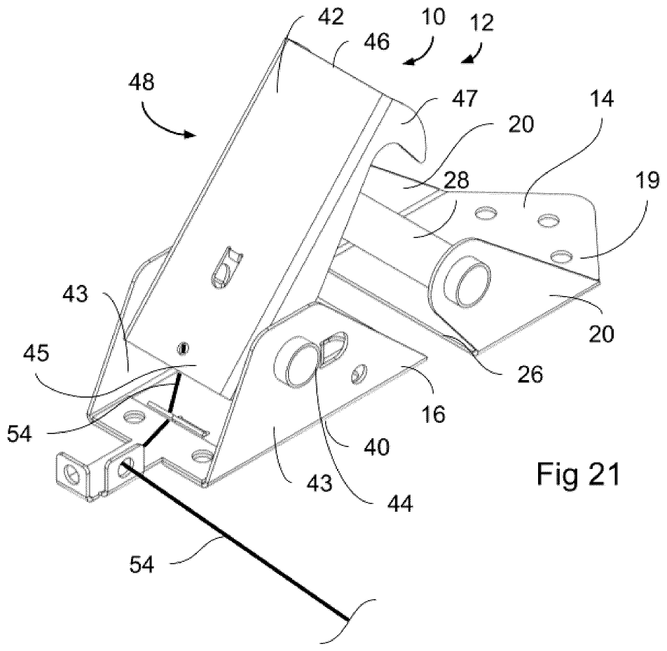

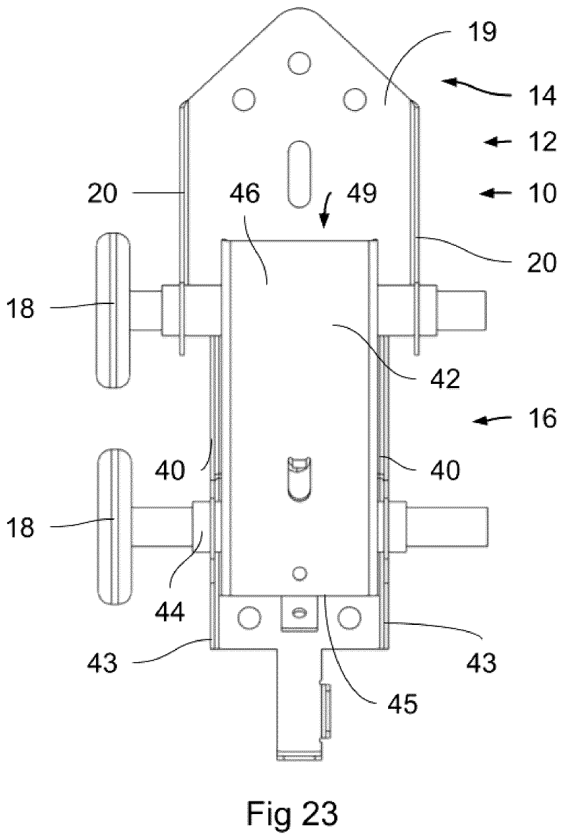

A substantially shown in FIGS. 1-23, one possible embodiment of invention 10 could be a double roller removably bifurcated garage door panel hinge 12 that may comprise two releasable hinge halves, a first hinge half 14 and second hinge half 16 that may be removably and pivotally connected to each other and a method of operation for same. Each hinge half, could be made of suitable material such a steel, may support a respective roller 18 (e.g., a wheel axle combination that movably attaches to rail/track set or pair.) The first hinge half 14 could comprise a first hinge half base 20, pair of first roller support arms 20 attached to the first hinge base 19, a double opened end first roller support tube 28 substantially supported by the first roller support arm pair 20 and a pair of rollers 18, a rail/track set attached to a garage structure (not shown) that forms a garage door opening (not shown) to which the movable garage panel door 26 may be movably applied.

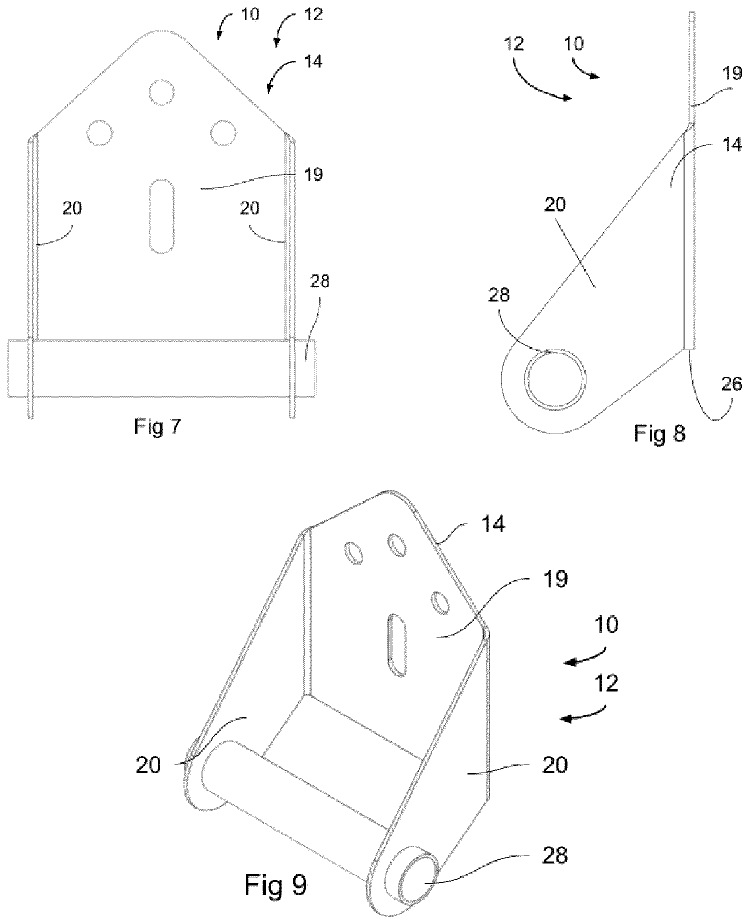

As substantially shown in FIGS. 7-9 and 23, the first hinge half base 19 could be a generally square or rectangular plate further defined by one flat end edge 26 and an opposing arrow-shaped end edge that are both continuously connected to together by two side edges. The pair of spaced-apart, parallel oriented first hinge roller support arms 20, each first roller support arm 20 being substantially perpendicularly attached to a respective side edge. Each roller support arm 20 may extend upward and outward away from the flat end edge 26 of the first hinge half base 19. Each first roller support arm 20 may further define a roller tube aperture that may accept and perpendicularly support a first double open-ended roller support tube 28. The first roller support arms 20 could locate the first roller support tube 28 up and out from flat end edge 26 of the first hinge half base 19 so that the first roller support tube 28 is not located over first hinge half base 19 but is otherwise located or projected up and away from the first hinge half base 19.

The first hinge half base 19 could further define a first set of fastener apertures through which one or more fasteners (e.g., screws-not shown) could attach the first hinge half 19 to a first (upper) garage door panel 30 that is generally located adjacent to a second (lower) garage door panel 32 during assembly of the garage panel door 24 (e.g., the first panel 30 could be positioned atop of the second panel 32.) The first hinge half 14 could be attached to first (upper) panel 30 proximate to first panel's side edge (e.g., near a rail or track of the rail/track set.) When the first hinge half 14 is so attached to the first (upper) panel 30, the first hinge half's flat end edge 26 could be bought to be aligned along the first (e.g., upper) panel's bottom edge 34.

This first half hinge's placement upon the first (upper) panel 30 could allow the first support roller tube 28 and an axle of roller 18 rotatably placed in a hollow interior of the first roller support tube 28 to be placed over the adjacent second (e.g., lower) panel 32 and over the second hinge half 16 when the connected hinges halves 19, 30 lie in the same plane (e.g., when the garage panel door is in the vertical or closed position or in the horizontal [angled] storage position.) The location of first roller support tube 28 may further facilitate proper panel movement though the curves of rail/track set.

As substantially shown in FIGS. 1-6, 10-21, the second hinge half 16 could comprise a second hinge half base 40; a clasp 42 for removably securing the first half hinge 14 to the second half hinge 16; a pair of second roller support arms 43 attached to the second hinge base 40, a double open-ended second roller support tube 44 as supported by the second roller support arm pair 43 and a roller 18 whose axle may be rotatable placed in a hollow interior of the second roller support tube 44.

The second hinge half base 40, generally being a square or rectangular plate defined by two second side edges and two second end edges, each of the two second side edges perpendicularly support a respective second roller tube support arm 43. Each second roller support arm 43 may extend upward from and over the second hinge half base 40. Each second roller support arm 43 may further define a roller tube aperture that may accept and perpendicularly support a second roller support tube 44. The second roller support arms 43 could locate the first roller support tube 44 up and over the second hinge half base 40.

The clasp 42 may be a rectangular plate substantially pivotally connected at first clasp end

45 to the second roller support tube 44 while the second clasp end 46 has a set of spaced-apart, parallel-oriented curved prongs 47 generally projecting perpendicularly downward from the second clasp end 46 towards the second hinge half base 40. The clasp 42 may rotate about the second roller support tube 44 between an upward position 48 (e.g., to substantially release the first hinge half 14, namely, by the first roller support tube 28) and a downward position 49. The clasp may be substantially removably engaged/pivotally connected to the first hinge half 14/first roller support tube 28.) In this manner, when the two hinge halves 14, 16 are removable connected together by the clasp 42, the hinge halves 14, 16 are free to rotate about their respective roller support tubes 44, 28. This multiple pivoting action when the connected adjacent panels commencement into the curved portions of rail/track set may provide sufficient freedom of movement that may prevent the rollers 18 of the double roller removably bifurcated garage door panel hinge 12 from binding up in the curved portions of the rail/track set. This multiple pivoting action may further allow a significant gap to open up between the otherwise adjacent panels 30, 32 moving the first panel's bottom edge 34 and second panel's top edge 36 apart from one another to possibly further assist the movement of said panels 30, 32 through the curved portion of the rail/track set.

The clasp 42 may further be biased (e.g., via a tension/extension spring 50 generally pivoting clasp 42 to the second hinge half base 40 and towards the downward clasp position 49.

The clasp 42 may yet further comprise a clasp release 52 to substantially allow an operator (not shown) to release one or all of the double roller and non-roller panel hinges removably connecting an adjacent panel pair together. In one embodiment, the clasp release 50 could be a release wire cable 54 attached at the first clasp end 45 and then be movably routed to and out from second hinge half base 40 (e.g., through an aperture in one of the second roller tube support arms 43) to be linked up with other such hinges removably connecting the adjacent panel pair. Pulling on the release wire cable 54 could overcome clasp spring bias(es) and move the clasp(s) 42 from the biased downward position 49 to the upward position 48 to substantially release the first half hinge(s) 14 from the second half hinge(s) 16 associated with the adjacent panel pair 30, 32.

The second hinge half base 40 could further define a second set of fastener apertures through which one or more fasteners (e.g., screws-not shown) could attach the first hinge half 14 to a first (upper) panel 30 that is generally located adjacent to a second (lower) panel 32 during assembly of the garage panel doo r 24 (e.g., the first [upper] panel 30 could be held atop of the second [lower] panel.) The second hinge half 16 could be attached to second (lower) panel 32 proximate to second (lower) panel's side edge (e.g., near a rail or track of the rail/track set.) As the second hinge half 16 is being so attached, the second hinge half could be bought to be proximate but not necessarily aligned along the second (lower) panel's top edge 36.

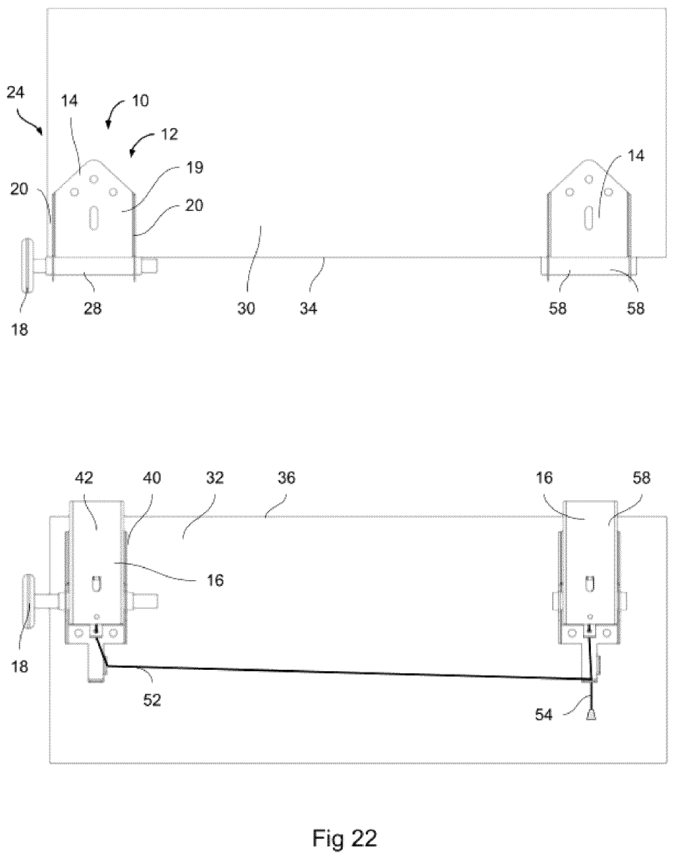

A substantially shown in FIG. 22, another version of the invention 10 could be a non-roller removably bifurcated garage door panel hinge 58 These non-roller hinges 58 could be used to connect adjacent panels 30, 32 at those panel sections (e.g., inner panel sections) of garage door panels that not adjacent to the track/rail set.) The non-roller garage panel door hinge 58 could have all the same features as the double roller removably bifurcated garage door panel hinge 12 with the exception of the non-roller removably bifurcated garage door panel hinge 58 would lack any rollers 18.

### Method of Operation

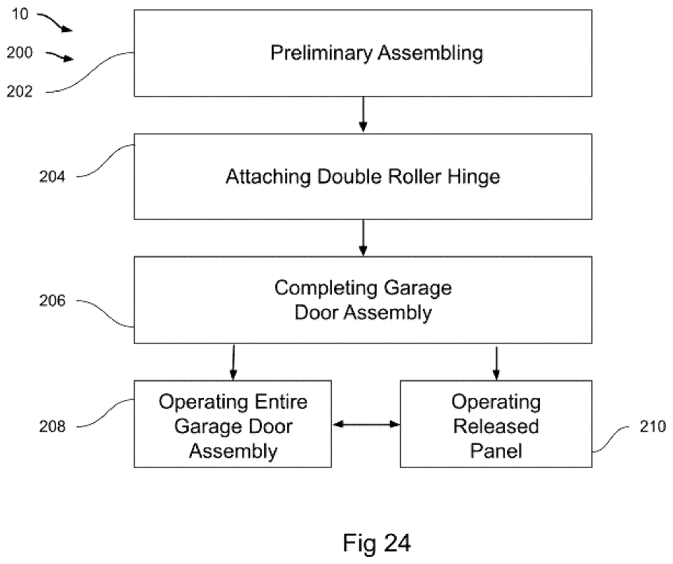

As subaerially shown in FIG. 24, one possible method or process 200 for generally operating the double roller/non-roller roller removably bifurcated garage door panel hinges could start with step 202, the preliminary assembling of the garage panel door parts. In this step, the unassembled garage panel door could come as a kit including hardware, hinges, door panels, counterweight system (e.g., coil spring [s]), motor unit (e.g., electrical door drive system), a set of railings, assembly instructions and the like. The set or pair of railings could be installed to the building structure/framework forming a garage door opening through which the invention could be employed to control egress and ingress to the building structure (e.g., garage) or part(s) thereof. In one embodiment, each rail of rail/track set could have a horizontal (closed/securing) rail portion (e.g., substantially straddling the garage door opening) connected to a curved portion as further connected to a horizonal (or angle) open/storage rail portion that generally projects away from the garage door opening. The two rails could be installed to substantially be in spaced-apart, parallel orientation to each other.

A motor drive system in combination with a spring-operated garage door weight compensation system may be generally used to move an assembled garage panel door between closed (e.g., vertical rail portions or vertical garage panel door positions) and open/door storage (e.g., horizontal/angled rail portions/horizontal positions). The motor drive system can be located proximate to the railing set, generally between the horizontal portions of the railing set. When the motor drive system is momentarily disconnected from the assembled door panel, the counterweight system also allows an operator to manually move the assembled panel door between closed and open/storage rail portions/garage panel door positions.

The rail/track pair along with garage panel door could be assembled to provide a “flush fit” closure by the garage door to the garage door opening framework to removably seal the garage door opening. This flush fit could require a “wedge” fitting by the double roller hinges of the invention to the garage panel door so when garage panel door, in the closed vertical position/vertical railing portions, is pressed by the roller/rail combined against the garage framework to removably seal the opening.

Several garage door panels could be brought proximate to the assembled railing set. One possible invention embodiment could have respective hinge plates previously attached to door panels (e.g., by the factory) with the exception of those wheeled hinge plates that are to be attached proximate to the left lateral panel ends. The top door panel and bottom panel may further have respective (e.g., right side) wheel roller mounts attached to the right-side lateral panel ends at this time. Upon the substantial completion of this step, the process could proceed to step 204, attaching door panel to the railing set.

Once step 202 is substantially completed, the method 200 could proceed to step 204 attaching the double roller bifurcated detachable hinges.

In step 204, attaching the double roller bifurcated detachable hinge, in one version, the double roller bifurcated detachable hinge may be detached into two hinge halves. Respective rollers may be inserted into the first (top) hinge roller support tube and second (bottom) hinge roller tube. The first (top) hinge half with an inserted roller may have the said roller movably inserted into a rail/track. The first (top) hinge half may be suitably attached to first so that the flat end edge (e.g., of the first hinge base) may be flush-mounted against the lower edge of the first (e.g., upper) garage door panel so that the first roller support tube extends past the first (e.g., upper) panel's lower edge (e.g., and substantially onto the second [e.g., bottom] panel and second hinge half when attached).

The second hinge half's respective roller may be inserted into the rail/track and a second (e.g., lower) panel may be brought into proper position between the rails/tracks and underneath the first (upper) panel. The second bottom hinge is adjusted upon and fastened to the second (lower) panel so the clasp prongs suitably overlaps and pivotally grasps the first roller support tube (e.g., first hinge half) to substantially provide proper clasp engagement with the first roller support tube (e.g., provide proper engagement of the first and second hinge halves.) The distance between the two hinge halve bases may be further adjusted so that the clasp can be freely opened and can engage first support roller tube. This adjustment could allow the first roller support tube, as the first support roller tube substantially moves into contact with clasp, to generally push open the clasp (e.g., when the two door panels are being brought adjacent again after being first separated.) The second (bottom) hinge half could be affixed to the garage door. This portion of the step could be repeated with another double roller bifurcated detachable hinge that can be applied to the two panels' other rail edges.

This entire step could be repeated until all the other garage door panels are connected by double roller bifurcated detachable hinges to the rail/track set. As required, the corners of the garage panel doors could be suitably movably attached to the rails/tracks by non-hinge supported rollers. As this step is substantially completed, the method 200 could proceed to step 206 attaching non-roller bifurcated detachable hinges to garage door panels.

In step 206 attaching non-roller bifurcated detachable hinges to garage door panels, the non-roller bifurcated detachable hinges are substantially double roller bifurcated detachable hinges without any rollers that need movable attachment to rails/tracks. The top hinge half could first be affixed to the first (top) panel with the edge of the top hinge flush with the lowest edge of the first (e.g., top) panel and secured with screws using the first set of fastener apertures preset panel holes. The top half hinge base's flat end edge could be flush mounted against the second (lower) panel's bottom edge so that the first roller support tube extends past the second (lower) panel's bottom edge (e.g., and onto the second [e.g., bottom] panel/second hinge half xx.) The second (bottom) hinge half then could be affixed/adjusted to the second (bottom) panel by using fasteners to suitably engage the second set of fastener apertures and preset holes on the second (lower) panel. to allow the clasp properly engage (and release) the first roller support tube as well as possible adjust adjusting the distances between two hinge halves. Once this step is substantially completed, the process may proceed onto step 206, completing garage panel door assembly.

In step 206, completing garage panel door assembly, the release wire cables can be suitably attached to their respective double roller bifurcated detachable hinges and non-roller bifurcated detachable hinges. The release wire cables from the double roller bifurcated detachable hinges and double roller bifurcated detachable hinges of a common lower edge/upper edge of adjacent panel pair could be run out to centrally located non-roller bifurcated detachable hinge located along the respective common lower edge/upper edge. These release cable wires could be suitably through wire guides applied to the garage panel door to be connected or coupled to the centrally located non-roller bifurcated detachable hinge's release cable wire. A pull or handle could be connected to the non-roller bifurcated detachable hinge's release cable wire so that an operator's tug upon the pull could release the first (top) panel form the second (bottom) panel. The clasp springs from the cable connected bifurcated detachable hinges could provide the force needed to reset the clasps and attached release wire cables back to the locked clasp down position.

Standard slide locks may be affixed to both rail/track ends of the panel at the panel (or other panels as required) to lock into corresponding rail/track apertures the lower panels in place during the separation of the upper panels or other methods. Other garage door features such a connecting the garage door weight compensation system to the assembled gauge panel door could be completed at this time. At the substantial conclusion of this step, the process 200 could proceed to either step 210 operating the separated panels or step 208 operating the entire garage door.

In step 208, operating the entire garage panel door, the garage panel door could be moved between the vertical “closed” position/vertical rail portions (e.g., where the garage panel door may be “flush-fit” with garage framework to removably sealed the garage door opening), the horizonal/angled storage position/horizontal rail portions by traversing the connecting curved rail portions. Upon activation/energization of the motor unit or manually moving garage panel door, as a panel enters the curved portion, the panel's double roller bifurcated detachable hinges (in having the first roller being offset from the first panel/first half hinge) may allow (along with the non-roller bifurcated detachable hinges) the first and second panel pair to pivot about their clasped connected roller support tubes and to pivot away from each other to open a significant panel edge gap between the respective upper and lower panel edges. The created panel edge gap occurs as first (upper) panel's lower edge and the second (lower) panel's upper edge are pulled away from one another (e.g., a single roller bifurcated detachable hinge could generally not accommodate the creation of such a panel edge gap.) This panel edge gap may allow the respective panel (of an adjacent panel pair) to move though the curved rail portions without the panel rollers generally binding up on the rails (that may occur with double roller bifurcated detachable hinges without an offset first roller support tube are used instead.) Further, the offset placement of the first rollers may substantially prevent the first panel, and every other subsequent following panel, from raising and jamming their lower panel edge into the garage opening framework. Once this step is substantially completed, the process 200 may proceed onto step 210, operating separate panels.

In step 210, operating separate panels, separating panels procedure could start with the slide locks generally being inserted into their respective rails/tracks to removable secure lower panel(s) in place and prevent their movement or shifting. The wire cable handle may be pulled to substantially unlock or otherwise open all bifurcated detachable hinges between two adjacent panels. The released panel(s) may then be lifted up manually or possibly by the activation of the garage door motor. In this manner, the released panels can be moved through the curved track portions onto the horizontal or angled storage position/horizontal or angled track portions. While in the horizontal or angled storage position/horizontal or angled track portions, the released panels could be reconnected to the top panel that is generally directly connected to the garage door motor.

Reconnecting separating panels procedure could start with energizing the garage door motor lower the separated panel(s) from the horizontal or angled position through the curved rail/track portion and back down into the vertical closed position. The bifurcated detachable hinges on the bottom edge of the released panel(s) (e.g., having the unattached first hinge halves with exposed first roller support tubes) will automatically reconnect with the secured panel(s) top edge with exposed clasps since the curved edge of the clasp prongs will slide past/over the top hinge halves first roller support tube roller tube. The clasps, being biased may snap close upon the first roller support tubes into clasp's closed or locking position. Once the garage door is fully reassembled, the slide locks may be released from their corresponding rails/tracks allowing the garage door to generally be operated as a standard garage door. Once this step is substantially completed, the process 200 may proceed onto step 208, operating the entire garage panel door.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A double roller, bifurcated, detachable garage door panel hinge comprising:
(A) a first hinge half and a second hinge half that removably and pivotally connected to each other by a clasp movably supported by the second hinge half;
(B) the first hinge half comprises a first half hinge base that further supports two spaced-apart first roller tube support arms, the first roller arms hold first roller support tube up and away from the first half hinge base, the first roller support tube further movable receives and rotatably supports first garage door roller;
(C) the second hinge half further comprises a second half hinge plate that further supports a second roller support tube up and over the second half hinge base, the second roller support tube further movable receives and rotatably supports a second garage door roller, the first roller support tube further pivotally supports the clasp that engages the first support roller to removably and pivotally connect the two hinge halves together;
wherein first half hinge is configured to attach to a first garage door panel and while the second hinge half is further configured to attach to an adjacent second garage door panel of a panel door to removably and initially hold the first door panel pivotally adjacent to the second door panel.

2. The double roller, bifurcated, detachable garage door panel hinge of claim 1 wherein when the first hinge half and second hinge half are removably pivotally connected together and lie in the same plane, the first roller support tube is placed up and over the second half hinge base.

3. The double roller, bifurcated, detachable garage door panel hinge of claim 2 wherein when the first hinge half and second hinge half are removably pivotally connected together and lie in the same plane, the first roller's axle is place up and over the second half hinge.

4. The double roller, bifurcated, detachable garage door panel hinge of claim 1 wherein the clasp is pivotally connected at first clasp end to the second roller support tube while prongs at the second clasp end removably and rotatably engage the first roller support tube to pivotally connect the hinge halves together.

5. The double roller, bifurcated, detachable garage door panel hinge of claim 1 wherein when the first hinge half and second hinge half are removably connected together by the clasp, both half hinges can pivot about their respective clasp attachment point.

6. The double roller, bifurcated, detachable garage door panel hinge of claim 2 wherein the clasp pivots between an upward release position and a downward connection position, the clasp being biased towards the downward connection position, the clasp further being connected by the first clasp end to a wire cable clasp release that when activated moves the clasp against the clasp bias and to the upward release position.

7. The double roller, bifurcated, detachable garage door panel hinge of claim 6 wherein wire cable clasp release is connected to several changes located upon an adjacent panel pair to allow for simultaneous clasp release to the wire cable connected hinges.

8. The double roller, bifurcated, detachable garage door panel hinge of claim 2 wherein the first hinge half and thee second half hinges hold their respective roller support tubes to the same depth height from the respective hinge half bases.

9. The double roller, bifurcated, detachable garage door panel hinge of claim 2 wherein the pivoting ability of the two hinge halves about the clasp allows for the attached adjacent door panels to move away from one another when the said door panels engage the curved rails of the rail track set.

10. A method for operating bifurcated, detachable garage door panel hinge comprising the following steps,
(A) providing a plurality of garage door panels that are configured to form a garage panel door, wherein a respective door panel pivots about an adjacent garage door panel;
(B) providing a set of a bifurcated, detachable garage door panel hinges that are comprised of first hinge half and second hinge half removably and movably connected to each other by a clasp supported by the second hinge half, the first hinge half supports the first roller support tube up and away from the first hinge half, the first roller support tube supporting a first garage door roller, the second hinge half supports a second roller support tube up and over the from the second hinge half hinge half, the second roller support tube movably supporting a second garage door roller;
(C) connecting the first half hinge to one door panel of the plurality of door panels;
(D) connecting the second half hinge plate to another door panel of the plurality of door panels; and
(E) activating the clasp to removably connect the first half hinge to the second half hinge.

11. Method of claim 10 wherein the activating the clasp further comprises a step of pivoting one end clasp about the second roller support tube.

12. Method of claim 10 wherein the activating the clasp further comprises a step of engaging the first roller support tube with the prongs supported by the other end of the clasp.

13. Method of claim 10 further comprises a step of pivoting each half hinge about their respective connection points to the clasp.

14. The method of claim 13 further comprising a step of moving apart adjacent garage door panels connected by said garage door panels hinges so the lower edge of the upper adjacent panel no longer contacts the upper edge of the lower adjacent panel.
